(19) United States
(12) Patent Application Publication
(10) Pub. No.: US 2009/0000554 A1
(43) Pub. Date: Jan. 1, 2009

(54) Methods and apparatus for delivering multiple substances in ovo

(76) Inventors: John H. Hebrank, Durham, NC (US); Thomas Bryan, Raleigh, NC (US)

Correspondence Address: MYERS BIGEL SIBLEY & SAJOVEC, PO BOX 37428, RALEIGH, NC, 27627, US

(21) Appl. No.: 11/821,951

(22) Filed: Jun. 26, 2007

(51) Int. Cl. A01K 45/00

(52) U.S. Cl. 119/6.8

(57) ABSTRACT

In ovo injection methods and apparatus are provided wherein multiple substances, particularly incompatible substances such as oil-based and aqueous-based substances, can be injected without reducing efficacy of the substances and without requiring complex mechanical injection devices. Injection of multiple substances may occur simultaneously or sequentially.

### FIELD OF THE INVENTION

The present invention relates generally to eggs and, more particularly, to methods and apparatus for processing eggs.

### BACKGROUND OF THE INVENTION

In many instances it is desirable to introduce a substance into a live avian egg prior to hatch. In ovo injections of various substances into avian eggs are typically employed in the commercial poultry industry to decrease post-hatch mortality rates and/or increase growth rates of hatched birds. Examples of substances that have been used for, or proposed for, in ovo injection include vaccines, antibiotics and vitamins. Examples of in ovo treatment substances and methods of in ovo injection are described in U.S. Pat. No. 4,458,630 to Sharma et al. and U.S. Pat. No. 5,028,421 to Fredericksen et al.

In ovo injections of substances typically occur by piercing the egg shell to create a hole therethrough (e.g., using a punch, drill, etc.), extending an injection needle through the hole and into the interior of the egg (in some cases into the avian embryo contained therein), and injecting the treatment substance through the needle via a peristaltic or diaphragm-style pump that is separate (i.e., physically separate and separately controlled) from the injection needle apparatus. An example of an in ovo injection device is disclosed in U.S. Pat. No. 4,681,063 to Hebrank; this device positions an egg and an injection needle in a fixed relationship to each other, and is designed for the high-speed automated injection of a plurality of eggs.

In some situations, it is desirable to inject multiple substances (e.g., vaccines) into a poultry embryo. Conventionally, this has been accomplished by mixing substances to be delivered in ovo within a single reservoir. Unfortunately, some substances for in ovo injection may be incompatible with each other. For example, it may be difficult to mix aqueous-based substances and oil-based substances such that the correct amount of each substance is injected into an egg. Moreover, mixing different incompatible substances may cause harm to each other, particularly if a certain period of time elapses. For example, an oil-based vaccine may harm an aqueous-based vaccine, thereby reducing efficacy of one or both substances.

Another drawback associated with mixing in ovo substances is when it is desirable to deliver one substance to a specific egg compartment and another substance to a different compartment (e.g., one biologic into muscle and another biologic into amnion). Because the substances are mixed, the effectiveness of one or both substances may be reduced.

Efforts to overcome the problems associated with injecting multiple substances into an egg have involved the use of delivery devices having multiple injection needles. Unfortunately, the use of multiple needles to deliver multiple substances into an egg can be complex and difficult to administer. Moreover, multiple holes may need to be created within an egg shell, which may be undesirable because of the increased risk of cracking and contamination. Inserting multiple needles through a single hole in an egg shell may require the hole to be larger than desirable and may increase the risk of cracking and contamination. Furthermore, multiple holes formed through the aircell membrane of an egg may increase the potential for bleeding and may negatively affect hatch of an embryo.

In addition, the use of multiple needles within a delivery device may require a larger gauge punch and/or a complex arrangement of hardware. For example, if one substance is more viscous (e.g., oil-based) than another, a larger diameter needle may be required for effective flow. Larger needles may also be desirable when injecting cell-based biologics in order to reduce shear forces on the substance which can reduce efficacy of the substance. If two different compartments are to be accessed by two needles then positioning two needles with a single delivery device may be difficult. Also, multiple needles, especially needles with differing lengths, may require more complex sanitation flow paths to bathe their entire active lengths and may actually resist good sanitation flow.

### SUMMARY

In view of the above discussion, in ovo injection methods and apparatus are provided wherein multiple substances, particularly incompatible substances such as oil-based and aqueous-based substances, can be injected with a single injection needle without reducing efficacy of the substances and without requiring complex mechanical injection devices. According to some embodiments of the present invention, a method of injecting multiple substances in ovo includes introducing a small opening into the shell of an egg, extending a delivery device (e.g., an injection needle of a delivery device) through the opening and into the egg, pumping first and second substances through the delivery device and into the egg, and retracting the delivery device from the egg. The first substance is pumped through the delivery device via a first substance delivery system and the second substance is pumped through the delivery device via a second substance delivery system. The first substance delivery system includes a first pump in fluid communication with a first substance reservoir, and the second substance delivery system includes a second pump in fluid communication with a second substance reservoir. The first and second substances are isolated from each other until the time of injection. As such, the time the two substances are in contact with each other is substantially reduced.

In some embodiments, the first and second substances are pumped substantially simultaneously through the delivery device via the respective first and second substance delivery systems. In other embodiments, the first and second substances are pumped sequentially through the delivery device via the respective first and second substance delivery systems. In this case, there is virtually no contact between the two substances.

When the first and second substances are pumped substantially simultaneously, an inert substance (e.g., water, saline, air, aqueous solutions, etc.) may be pumped through the delivery device prior to and/or after pumping the first and second substances therethrough. The inert substance may be pumped through the delivery device at various stages of operation of the delivery device. For example, the inert substance may be pumped through the delivery device as the delivery device is being lowered into an egg or as the delivery device is being retracted from an egg. Alternatively, the inert substance may be pumped through the delivery device prior to lowering the delivery device into an egg or after the delivery device has been lowered into an egg.

When the first and second substances are pumped sequentially, an inert substance may be pumped through the delivery device after the first substance is pumped through the delivery device and into an egg, but before the second substance is pumped through the delivery device.

According to some embodiments of the present invention, a method of injecting multiple substances in ovo includes introducing a small opening into the shell of an egg, extending a delivery device through the opening to a first location within the egg, and pumping a first substance through the delivery device and into the egg at the first location. The delivery device is then moved to a second location within the egg, a second substance is pumped through the delivery device and into the egg at the second location. For example, one location may be within an embryo of an egg, and the other location may be within the amnion of the egg. In some embodiments, location may be based upon depth within an egg. For example, one location may be at a depth of about one inch (1″) from the opening in the egg shell, and the other location may be at a depth of about one and one-half inches (1.5″) from the egg shell opening.

The first substance is pumped through the delivery device via a first substance delivery system and the second substance is pumped through the delivery device via a second substance delivery system. The first substance delivery system includes a first pump in fluid communication with a first substance reservoir, and the second substance delivery system includes a second pump in fluid communication with a second substance reservoir. As such, the first and second substances are isolated from each other.

In some embodiments, pumping of the first substance through the delivery device may begin prior to the delivery device reaching the first location. Similarly, pumping of the second substance through the delivery device may begin prior to the delivery device reaching the second location.

In some embodiments, an inert substance is pumped through the delivery device prior to and/or after pumping the first and second substances therethrough. The inert substance may be pumped through the delivery device at various stages of operation of the delivery device. For example, the inert substance may be pumped through the delivery device as the delivery device is being lowered into an egg or as the delivery device is being retracted from an egg. Alternatively, the inert substance may be pumped through the delivery device prior to lowering the delivery device into an egg or after the delivery device has been lowered into an egg. An inert substance may be pumped through the delivery device after the first substance is pumped through the delivery device into the first location, but before the second substance is pumped through the delivery device at the second location.

According to some embodiments of the present invention, an in ovo injection apparatus includes a delivery device that is configured to deliver predetermined dosages of two or more substances into an egg, a first substance delivery system that pumps a first substance through the delivery device, and a second substance delivery system that pumps a second substance through the delivery device. The first and second substances may be delivered in ovo substantially simultaneously or sequentially.

In some embodiments, the first substance delivery system includes a first pump in fluid communication with a first substance reservoir, and the second substance delivery system includes a second pump in fluid communication with a second substance reservoir.

In some embodiments, an opening in the shell of an egg is formed via a tubular punch. An injection needle is positioned within the tubular punch and is configured for movement therethrough and through an opening in an egg shell formed by the tubular punch for delivery of the first and second substances into an egg. A sanitizing system may be provided that flushes the delivery device (e.g., a punch and needle, etc.) with a sanitizing solution after pumping the first and second substances into an egg is provided.

In some embodiments, an inert substance delivery system is provided that pumps an inert solution (e.g., water, saline, air, etc.) through the delivery device. For example, the inert substance delivery system may be configured to pump an inert solution through the delivery device before and/or after the first and second substances are pumped through the delivery device. When sequential delivery of two substances occurs, the inert substance delivery system may be configured to pump an inert solution through the delivery device after the first substance is pumped through the delivery device, but before the second substance is pumped through the delivery device.

According to some embodiments of the present invention, an in ovo injection apparatus includes a delivery device that is configured to deliver a predetermined dosage of a first substance at a first location within an egg and a predetermined dosage of a second substance at a second, different location within the egg. For example, one location may be within an embryo of an egg, and the other location may be within the amnion of the egg. In some embodiments, location may be based upon depth within an egg. For example, one location may be at a depth of about one inch (1″) from the opening in the egg shell, and the location may be at a depth of about one and one-half inches (1.5″) from the egg shell opening.

In some embodiments of the present invention, a first substance delivery system includes a first pump in fluid communication with a first substance reservoir that is configured to pump the first substance through the delivery device. A second substance delivery system includes a second pump in fluid communication with a second substance reservoir that is configured to pump the second substance through the delivery device. An inert substance delivery system is provided that includes a pump in fluid communication with an inert substance reservoir. The inert substance delivery system is configured to pump an inert solution through the delivery device. For example, the inert substance delivery system may be configured to pump an inert solution through the delivery device before and/or after the first and second substances are pumped through the delivery device. The inert substance delivery system may be configured to pump an inert substance through the delivery device at various stages of operation of the delivery device. For example, the inert substance may be pumped through the delivery device as the delivery device is being lowered into an egg or as the delivery device is being retracted from an egg. Alternatively, the inert substance may be pumped through the delivery device prior to lowering the delivery device into an egg or after the delivery device has been lowered into an egg. An inert substance may be pumped through the delivery device after the first substance is pumped through the delivery device into the first location, but before the second substance is pumped through the delivery device at the second location.

Embodiments of the present invention may be utilized with in ovo injection systems that inject multiple eggs at the same time. For example, according to some embodiments of the present invention, an in ovo injection apparatus includes an egg carrier that holds a plurality of eggs and provides external access to the eggs, and a plurality of delivery devices positioned above the carrier, wherein each delivery device is configured to deliver predetermined dosages of multiple substances into a respective egg. First and second substance delivery systems are associated with each respective delivery device and are configured to pump first and second substances through each delivery device simultaneously or sequentially as described herein.

According to some embodiments of the present invention, a method of injecting multiple substances in ovo includes introducing a small opening into the shell of an egg, extending a delivery device through the opening to a first location within the egg, sequentially pumping first and second substances through the delivery device and into the egg, and retracting the delivery device from the egg. The first and second substances are pumped via a pump that is in selective fluid communication with a first substance reservoir and a second substance reservoir. The pump is isolated from the second substance reservoir when the first substance is pumped through the delivery device and the pump is isolated from the first substance reservoir when the second substance is pumped through the delivery device. In some embodiments, the pump is integral with the delivery device. In other embodiments, the pump is external to the delivery device.

According to some embodiments of the present invention, an in ovo injection apparatus includes a delivery device that is configured to deliver predetermined dosages of two or more substances into an egg, and a substance delivery system that pumps first and second substances sequentially through the delivery device. The substance delivery system includes a pump that is in selective fluid communication with a first substance reservoir and a second substance reservoir. The pump is isolated from the second substance reservoir when the first substance is pumped through the delivery device, and the pump is isolated from the first substance reservoir when the second substance is pumped through the delivery device.

In some embodiments, the substance delivery system is in selective fluid communication with an inert substance reservoir and is configured to pump an inert substance from the reservoir through the delivery device. In some embodiments, the pump is integral with the delivery device. In other embodiments, the pump is external to the delivery device.

According to some embodiments of the present invention, an in ovo injection apparatus includes an egg carrier that holds a plurality of eggs and provides external access to the eggs, and a plurality of delivery devices positioned above the carrier, wherein each delivery device is configured to deliver predetermined dosages of multiple substances sequentially into a respective egg. A substance delivery system includes a pump that is in selective fluid communication with a first substance reservoir, a second substance reservoir, and with each of the delivery devices. The pump is isolated from the second substance reservoir when the first substance is pumped through the delivery devices, and the pump is isolated from the first substance reservoir when the second substance is pumped through the delivery devices.

In some embodiments, the substance delivery system is in selective fluid communication with an inert substance reservoir and is configured to pump an inert substance from the insert substance reservoir through each delivery device.

According to some embodiments of the present invention, an in ovo injection apparatus includes an egg carrier that holds a plurality of eggs and provides external access to the eggs, and a plurality of delivery devices positioned above the carrier, wherein each delivery device is configured to deliver predetermined dosages of multiple substances sequentially into a respective egg via a pump integral with the delivery device. Each delivery device pump is in selective fluid communication with a first substance reservoir and a second substance reservoir. Each delivery device pump is isolated from the second substance reservoir when the first substance is pumped therethrough, and each delivery device pump is isolated from the first substance reservoir when the second substance is pumped therethrough.

In some embodiments of the present invention, each delivery device pump is in selective fluid communication with an inert substance reservoir and is configured to pump an inert substance from the inert substance reservoir through the delivery device.

### BRIEF DESCRIPTION OF THE DRAWINGS

FIG. 1 is a partial cross-sectional view of an in ovo injection delivery device that can deliver multiple substances into an egg, according to some embodiments of the present invention.

FIG. 2 is side view of an in ovo injection apparatus having a plurality of injection devices that can deliver multiple substances into a plurality of eggs, according to some embodiments of the present invention.

FIG. 3 is a schematic illustration of an in ovo injection apparatus for injecting multiple substances into multiple eggs in accordance with some embodiments of the present invention.

FIG. 4 is a schematic illustration of an in ovo injection apparatus for injecting multiple substances into multiple eggs in accordance with other embodiments of the present invention.

FIGS. 5-7 are flow charts illustrating operations for injecting multiple substances into multiple eggs in accordance with some embodiments of the present invention.

FIG. 8 is a schematic illustration of an in ovo injection apparatus for injecting multiple substances into multiple eggs in accordance with other embodiments of the present invention.

FIG. 9 is a schematic illustration of an in ovo injection apparatus for injecting multiple substances into multiple eggs in accordance with other embodiments of the present invention.

FIG. 10 is a schematic illustration of an in ovo injection apparatus for injecting multiple substances into multiple eggs in accordance with other embodiments of the present invention.

FIG. 11 is a schematic illustration of an in ovo injection apparatus for injecting multiple substances into multiple eggs in accordance with other embodiments of the present invention.

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines are used for clarity to indicate continuation, and may illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

Embodiments of the present invention may be used to inject multiple substances into any type of avian egg including, but not limited to, chicken eggs, turkey eggs, duck eggs, geese eggs, quail eggs, pheasant eggs, parakeet eggs, parrot eggs, cockatoo eggs, cockatiel eggs, ostrich eggs, emu eggs and the like.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various substances, elements, components, regions, layers and/or sections, these elements, components, regions, layers and/or sections should not be limited by these terms. These terms are only used to distinguish one substance, element, component, region, layer or section from another substance, element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

The term “incompatible” when used in reference to two or more substances injected in ovo, means that the substances do mix well together and/or should not be mixed together. Exemplary incompatible substances are oil-based emulsions and aqueous-based emulsions. Mixing of some incompatible substances may reduce the efficacy of one or both of the substances.

An exemplary in ovo processing system that may be utilized to inject multiple substances, particularly incompatible substances such as oil-based and aqueous-based substances, into eggs in accordance with embodiments of the present invention, is the INOVOJECT® automated injection device (Embrex, Inc., Research Triangle Park, North Carolina). However, embodiments of the present invention may be utilized with any in ovo processing device.

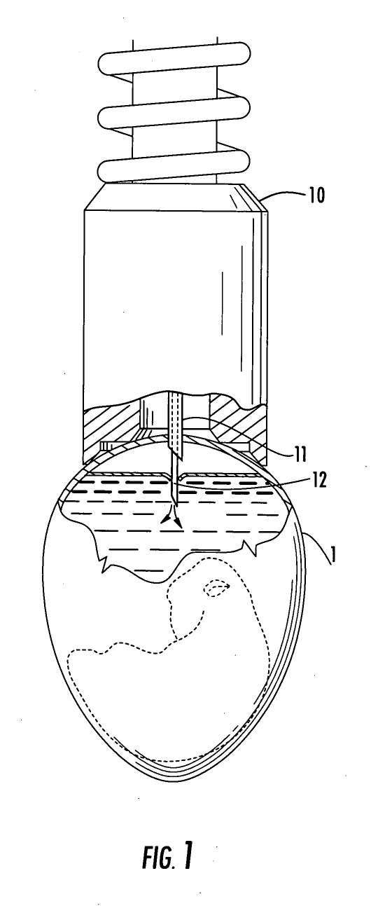

FIG. 1 illustrates a portion of an injection delivery device 10 of the INOVOJECT® automated injection device. The injection delivery device 10 includes a punch 11 configured to form an opening in the shell of an egg 1. An injection needle 12 is movably disposed within the punch 11 (i.e., the punch 11 substantially concentrically surrounds the respective needle 12) so that after the punch 11 makes an opening in the shell of an egg, the injection needle 12 can move through the punch 11 and respective opening of an egg shell to an injecting position(s) within an egg for delivery of multiple substances therein. See, for example, U.S. Pat. No. RE35,973. However, various types of injection delivery devices may be utilized in accordance with embodiments of the present invention. Embodiments of the present invention are not limited to the illustrated injection delivery device.

After injection of multiple substances into an egg via the injection delivery device 10 of FIG. 1, for example, portions of the punch and needle 11, 12 are treated with a sanitizing fluid, for example, via spraying, dipping, allowing sanitizing fluid to flow through the needle and/or punch, etc. Exemplary sanitizing fluids include, but are not limited to, hypochlorite solutions, sodium hydroxide solutions, hydrogen peroxide solutions, and ozonated water.

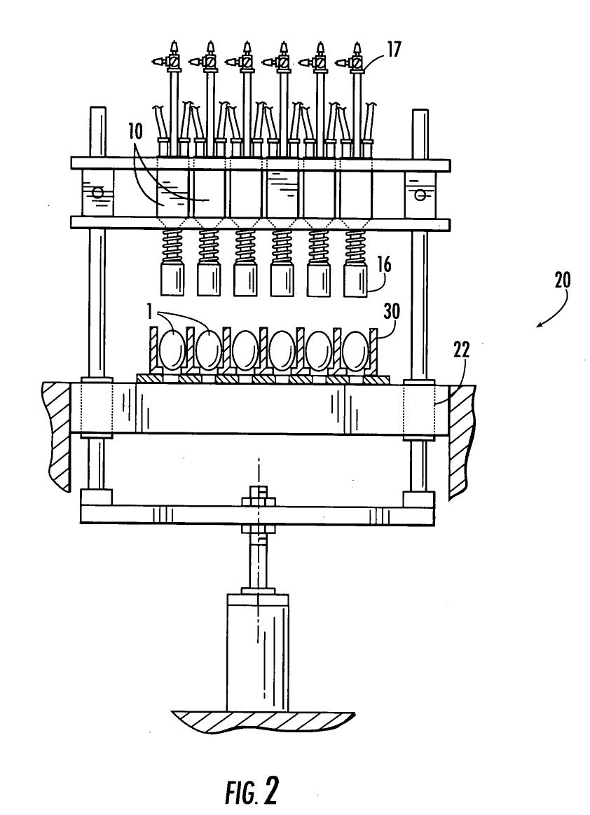

FIG. 2 illustrates an in ovo injection apparatus 20 having a plurality of the injection delivery devices 10 of FIG. 1 that can be configured to inject multiple substances, particularly incompatible substances such as oil-based and aqueous-based substances, in multiple eggs according to some embodiments of the present invention. The illustrated apparatus 20 includes a stationary base 22, and a plurality of injection delivery devices 10. A flat 30 holds a plurality of eggs 1 in a substantially upright position. The flat 30 is configured to provide external access to predetermined areas of the eggs 1. Each egg 1 is held by the flat 30 so that a respective end thereof is in proper alignment relative to a corresponding one of the injection delivery devices 10 as the injection delivery device 10 advances towards the base 22 of the apparatus. However, in ovo injection devices may inject eggs oriented in various orientations. Embodiments of the present invention are not limited only to in ovo injection devices that inject eggs in the illustrated orientation.

Although sets of eggs conventionally are carried in egg flats, any type of container for carrying eggs may be utilized in accordance with embodiments of the present invention. Flats may contain any number of rows, such as seven rows of eggs, with rows of six and seven being most common. Moreover, eggs in adjacent rows may be parallel to one another, as in a “rectangular” flat, or may be in a staggered relationship, as in an “offset” flat. Examples of suitable commercial flats include, but are not limited to, the “CHICKMASTER 54” flat, the “JAMESWAY 42” flat and the “JAMESWAY 84” flat (in each case, the number indicates the number of eggs carried by the flat). Egg flats are well known to those of skill in the art and need not be described further herein.

Each of the plurality of injection delivery devices 10 has opposing first and second ends 16, 17. The delivery devices 10 have a first extended position and a second retracted position, as is known in the art. Upon extension of an injection delivery device 10, the first end 16 is configured to contact and rest against predetermined areas of an external egg shell. From this position, a punch 11 (FIG. 1) within the delivery device 10 forms a small opening in the shell and an injection needle 12 (FIG. 1) is inserted therethrough to deliver one or more substances into the egg. When not injecting, the injection delivery devices 10 are retracted to rest a predetermined distance above the eggs 1 and stationary base 22. Alternatively, the base 22 can be longitudinally slidably moveable to position the eggs 1 in proper position relative to the injection heads 10.

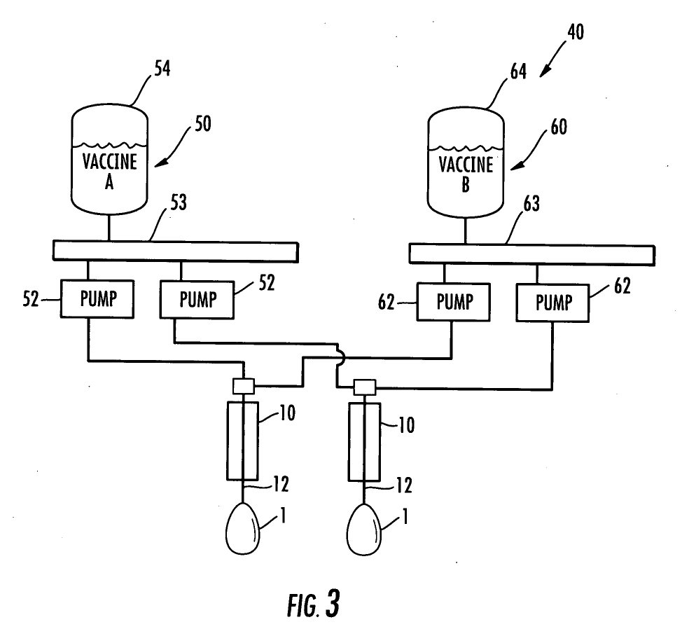

FIG. 3 is a schematic illustration of an in ovo injection apparatus 40 for injecting multiple substances into multiple eggs in accordance with some embodiments of the present invention. The illustrated apparatus 40 includes a pair of delivery devices 10, each configured to deliver predetermined dosages (e.g., 50 uL, etc.) of two or more substances into an egg. However, it is understood that an apparatus according to embodiments of the present invention may have any number of delivery devices 10. Each delivery device 10 may be configured to deliver various amounts of two or more substances, as well. The illustrated apparatus 40 also includes a first substance delivery system 50 that pumps a first substance through the delivery devices 10, and a second substance delivery system 60 that pumps a second substance through the delivery devices 10. The first substance delivery system 50 includes a respective pump 52 in fluid communication with a first substance reservoir 54 and with each of the delivery devices 10. Similarly, the second substance delivery system 60 includes a respective pump 62 in fluid communication with a second substance reservoir 64 and with each of the delivery devices 10. Pumps 52 in the illustrated first substance delivery system 50 are primed via a fluid manifold 53 which is in fluid communication with the first substance reservoir 54. Similarly, pumps 62 in the illustrated second substance delivery system 60 are primed via a fluid manifold 63 which is in fluid communication with the second substance reservoir 64.

Embodiments of the present invention are not limited to the illustrated configurations of the first and second substance delivery systems 50, 60. For example, more than one substance reservoir may be utilized for each system 50, 60. Moreover, the use of a manifold 53, 63 for each system 50, 60 is not required. Pumps 52, 62 may be in fluid communication with substance reservoir(s) 54, 64 directly. In addition, a separate pump 52, 62 is not required for each delivery device 10. One pump 52, 62 may deliver first and second substances to more than one delivery device 10.

The illustrated apparatus 40 may be configured to deliver first and second substances in ovo substantially simultaneously or sequentially as described herein. Moreover, the illustrated apparatus 40 may be configured to deliver a predetermined dosage of one substance to a first location within an egg and a predetermined dosage of a second substance to a second, different location within the egg. For example, each delivery device 10 may be configured to deliver a substance within an embryo of an egg, and within the amnion of the egg. In some embodiments, location may be based upon depth within an egg. Each delivery device 10 may be configured to insert an injection needle to different depths within an egg. For example, each delivery device 10 may be configured to insert an injection needle within an egg to a location of about one inch (1″) from an opening in the egg shell, and to another location at a depth of about one and one-half inches (1.5″) from the egg shell opening.

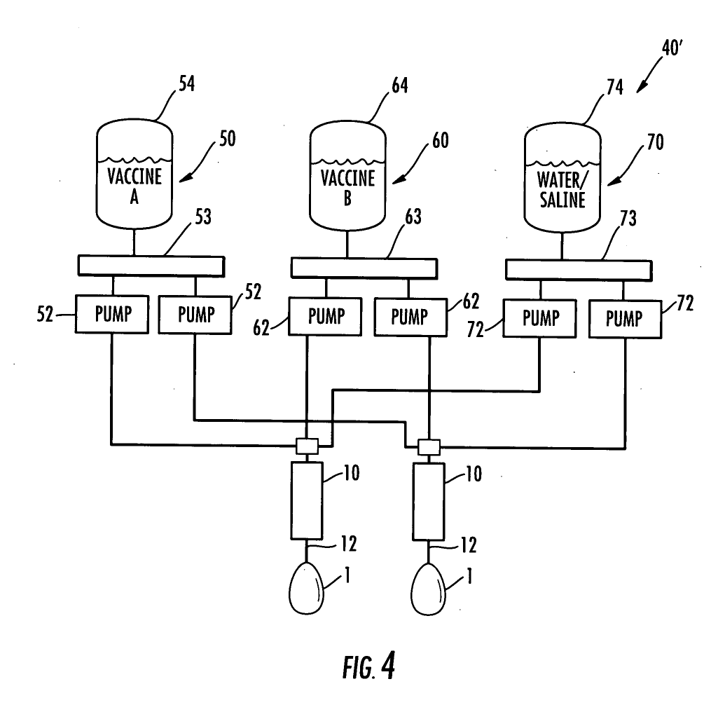

FIG. 4 is a schematic illustration of an in ovo injection apparatus 40′ for injecting multiple substances into multiple eggs in accordance with some embodiments of the present invention. The illustrated apparatus 40′ includes a pair of delivery devices 10, each configured to deliver predetermined dosages of two or more substances into an egg. However, it is understood that an apparatus according to embodiments of the present invention may have any number of delivery devices 10. The illustrated apparatus 40′ also includes a first substance delivery system 50 that pumps a first substance through the delivery devices 10, and a second substance delivery system 60 that pumps a second substance through the delivery devices 10. The first substance delivery system 50 includes a pump 52 in fluid communication with a first substance reservoir 54 and with each of the delivery devices 10. Similarly, the second substance delivery system 60 includes a pump 62 in fluid communication with a second substance reservoir 64 and with each of the delivery devices 10. Pumps 52 in the illustrated first substance delivery system 50 are primed via a fluid manifold 53 which is in fluid communication with the first substance reservoir 54. Similarly, pumps 62 in the illustrated second substance delivery system 60 are primed via a fluid manifold 63 which is in fluid communication with the second substance reservoir 64.

Embodiments of the present invention are not limited to the illustrated configurations of the first and second substance delivery systems 50, 60. For example, more than one substance reservoir may be utilized for each system 50, 60. Moreover, the use of a manifold 53, 63 for each system 50, 60 is not required. Pumps 52, 62 may be in fluid communication with substance reservoir(s) 54, 64 directly. In addition, a separate pump 52, 62 is not required for each delivery device 10. One pump 52, 62 may deliver first and second substances to more than one delivery device 10.

The illustrated apparatus 40′ may be configured to deliver first and second substances in ovo substantially simultaneously or sequentially as described herein. Moreover, the illustrated apparatus 40′ may be configured to deliver a predetermined dosage of one substance at a first location within an egg and a predetermined dosage of a second substance at a second, different location within the egg, as described herein.

The illustrated apparatus 40′ also includes an inert substance delivery system 70 that is configured to pump an inert solution through the delivery devices 10, as described herein. The illustrated inert substance delivery system 70 includes a respective pump 72 in fluid communication with an inert substance reservoir 74 and with each of the delivery devices 10. Pumps 72 in the illustrated inert substance delivery system 70 are primed via a fluid manifold 73 which is in fluid communication with the inert substance reservoir 54.

The inert substance delivery system 70 is configured to pump an inert solution through each delivery device 10 (i.e., through the injection needle 12 of each delivery device 10) before and/or after the first and second substances are pumped therethrough. The inert substance delivery system 70 may be configured to pump an inert substance through the delivery devices 10 at various stages of operation of the delivery devices 10. For example, an inert substance may be pumped through a delivery device 10 as the delivery device injection needle 12 is being lowered into an egg or as the delivery device injection needle 12 is being retracted from an egg. Alternatively, an inert substance may be pumped through a delivery device prior to lowering the delivery device injection needle 12 into an egg or after the delivery device injection needle 12 has been lowered into an egg. An inert substance may be pumped through a delivery device after the first substance is pumped through the delivery device into a first location, but before the second substance is pumped through the delivery device at a second location.

Embodiments of the present invention are not limited to the illustrated configuration of the inert substance delivery system 70. For example, more than one inert substance reservoir 74 may be utilized. Moreover, the use of a manifold 73 is not required. Pumps 72 may be in fluid communication with inert substance reservoir(s) 74 directly. In addition, a separate pump 72 is not required for each delivery device 10. One pump 72 may deliver an inert substance to more than one delivery device 10.

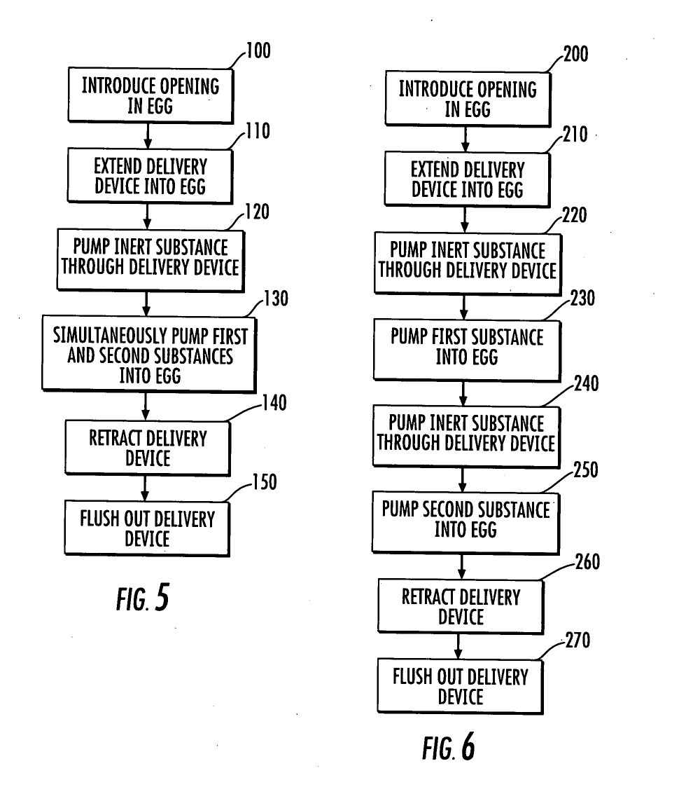

Referring to FIG. 5, methods of in ovo injection of multiple substances substantially simultaneously, in accordance with embodiments of the present invention, are illustrated. Initially, a small opening is introduced into the shell of an egg (Block 100) and a delivery device is extended through the opening and into the egg (Block 110). It is understood that the portion of the illustrated delivery device 10 that is extended through the egg shell opening is the injection needle 12. Thus, references to “extending a delivery device through the opening” refers to an injection needle or other lumen configured to deliver one or more substances into an egg with respect to the illustrated delivery device 10. Other in ovo delivery devices utilized in accordance with embodiments of the present invention may have additional portions that are extended into an egg.

Still referring to FIG. 5, an inert substance is pumped through the delivery device, i.e., through the lumen of the delivery device injection needle (Block 120). Exemplary inert substances include, but are not limited to, water, saline, air, aqueous solutions, etc. The inert substance may be pumped through the injection needle as the injection needle is moved into the egg, or after the injection needle has reached the desired location within the egg. First and second substances are then pumped substantially simultaneously into the egg (Block 130) and the delivery device is retracted from the opening (Block 140).

In some embodiments of the present invention, an inert substance is pumped through the injection needle after the first and second substances have been injected into the egg. As such, the operations represented by Block 120 may not occur, i.e., an inert substance may not be pumped through the injection needle prior to pumping the first and second substances through the needle. Injection of the inert substance after injection of the first and second substances may begin while the injection needle is stationary within the egg or as it is being retracted from the egg. Alternatively, the inert substance may be pumped through the injection needle after the injection needle has been completely removed from the egg.

Still referring to FIG. 5, in some embodiments of the present invention, the lumen of an injection needle may be flushed with the same or another inert substance at the end of an injection (Block 150). For example, water may be flushed through an injection needle to remove traces of the first and second substances and/or the other inert substance. In addition or alternatively, this step may include flushing a sanitizing fluid through and around the injection needle.

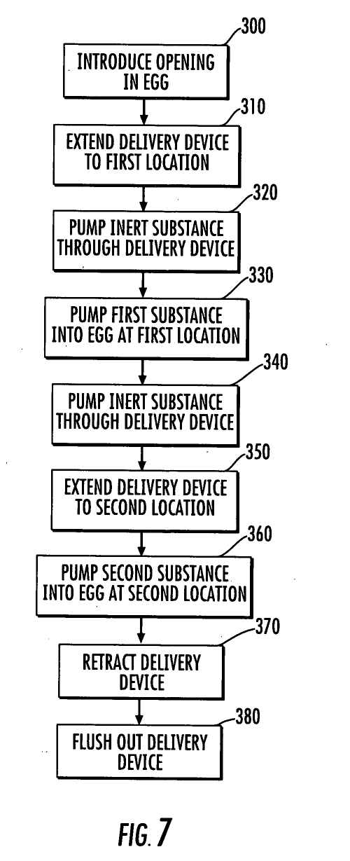

Referring to FIG. 6, methods of in ovo injection of multiple substances sequentially, in accordance with other embodiments of the present invention, are illustrated. Initially, a small opening is introduced into the shell of an egg (Block 200) and an injection needle of a delivery device is extended through the opening and into the egg (Block 210). An inert substance may be pumped through the lumen of the injection needle (Block 220) followed by the delivery of a first substance into the egg via the injection needle (Block 230). Injection of the inert substance prior to injection of the first substance may begin as the injection needle is being extended into the egg or when the injection needle is stationary within the egg. An inert substance may be pumped through the injection needle (Block 240) followed by the delivery of a second substance into the egg via the injection needle (Block 250). The delivery device is then retracted from the opening (Block 260).

In some embodiments of the present invention, an inert substance is pumped through the injection needle after the second substance has been injected into the egg. As such, the operations represented by Block 220 may not occur, i.e., an inert substance need not be pumped through the injection needle prior to pumping the first substance through the needle. Injection of the inert substance after injection of the second substance may begin while the injection needle is stationary within the egg or as it is being retracted from the egg. Alternatively, the inert substance may be pumped through the injection needle after the injection needle has been completely removed from the egg.

Still referring to FIG. 6, in some embodiments of the present invention, the lumen of an injection needle may be flushed with the same or another inert substance at the end of an injection (Block 270). For example, water may be flushed through an injection needle to remove traces of the first and second substances and/or the inert substance. In addition or alternatively, this step may include flushing a sanitizing fluid through and around the injection needle.

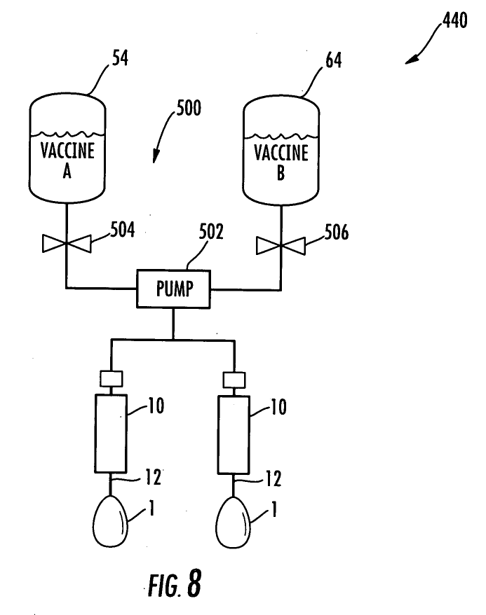

Referring to FIG. 7, methods of in ovo injection of multiple substances at different locations within an egg, in accordance with other embodiments of the present invention, are illustrated. Initially, a small opening is introduced into the shell of an egg (Block 300). An injection needle of a delivery device is extended through the opening and into the egg to a first location (Block 310). An inert substance is pumped through the injection needle (Block 320), followed by the delivery of a first substance through the injection needle into the egg at the first location (Block 330). Injection of the first substance may begin while the injection needle is being moved into position at the first location or after the injection needle is stationary within the egg at the first location.

An inert substance is pumped through the injection needle (Block 340) after delivery of the first substance. The injection needle is extended to a second location within the egg (Block 350) and a second substance is delivered through the injection needle into the egg at the second location (Block 360). Delivery of the inert substance prior to injection of the second substance may begin as the injection needle is being extended to the second location within the egg or when the injection needle is stationary within the egg at the second location.

In some embodiments, injection of the second substance may begin while the injection needle is being moved into position at the second location or after the injection needle is stationary within the egg at the second location. If injection of the second substance begins while the injection needle is being moved into position at the second location, delivery of the inert substance is completed prior to the injection needle arriving at the second location.

In some embodiments, an inert substance is pumped through the injection needle after delivery of the second substance, and the injection needle is retracted (Block 370). As such, the operations represented by Block 320 may not occur, i.e., an inert substance need not be pumped through the injection needle prior to pumping the first substance through the needle at the first location. Injection of the inert substance after injection of the second substance may begin while the injection needle is stationary within the egg or as it is being retracted from the egg. Alternatively, the inert substance may be pumped through the injection needle after the injection needle has been completely removed from the egg.

Still referring to FIG. 7, in some embodiments of the present invention, the lumen of an injection needle may be flushed with the same or another inert substance at the end of an injection cycle for an egg (Block 380). For example, water may be flushed through an injection needle to remove traces of the first and second substances and/or the inert substance. In addition or alternatively, this step may include flushing a sanitizing fluid through and around the injection needle.

FIG. 8 is a schematic illustration of an in ovo injection apparatus 440 for injecting multiple substances sequentially into multiple eggs in accordance with some embodiments of the present invention. The illustrated apparatus 440 includes a pair of delivery devices 10, each configured to sequentially deliver predetermined dosages of two or more substances into an egg. However, it is understood that an apparatus according to embodiments of the present invention may have any number of delivery devices 10. The illustrated apparatus 440 also includes a substance delivery system 500 that pumps first and second substances sequentially through the needle 12 of each delivery device 10. The substance delivery system includes a pump 502 that is in selective fluid communication with a first substance reservoir 54 and a second substance reservoir 64. The pump 502 can be isolated from the first and second substance reservoirs 54, 64 via valves 504, 506, as illustrated. For example, when pumping the first substance through each delivery device, valve 504 is opened and valve 506 is closed to isolate the pump 502 from the second substance reservoir such that the second substance cannot be drawn from the second substance reservoir 64 at the same time as the first substance. Similarly, when pumping the second substance through each delivery device, valve 506 is opened and valve 504 is closed to isolate the pump 502 from the first substance reservoir such that the first substance cannot be drawn from the first substance reservoir 54 at the same time as the second substance. Valves 504, 506 can be any type of valves. Pump 502 can be any type of pump, such as a peristaltic pump, etc.

Embodiments of the invention illustrated in FIG. 8 may be utilized to sequentially deliver multiple substances to different locations within an egg 1. For example, valves 504, 506 may be initially closed as an injection needle is moved into embryo muscle. Valve 504 is then opened, connecting the first substance reservoir 54 containing vaccine “A” to the pump 502. The pump 502 delivers a predetermined amount of vaccine “A” (e.g., 50 uL, etc.) through the injection needle 12 and into the embryo muscle. The delivery device is moved upwardly (or downwardly) within the egg such that the injection needle is located within the amnion of the egg. Valve 504 is closed and valve 506 is opened, connecting the second substance reservoir 64 containing vaccine “B” to the pump 502. The pump 502 delivers a predetermined amount of vaccine “B” (e.g., 50 uL, etc.) through the injection needle 12 and into the embryo amnion. Valve 506 is then closed and the injection needle 12 is withdrawn from the egg 1.

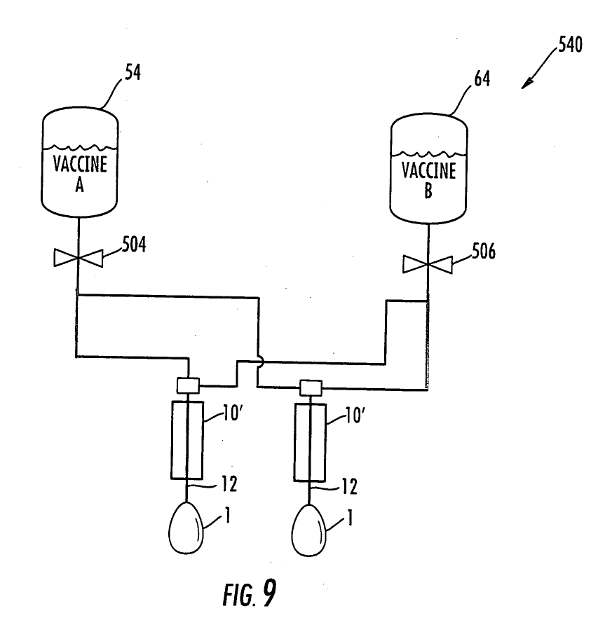

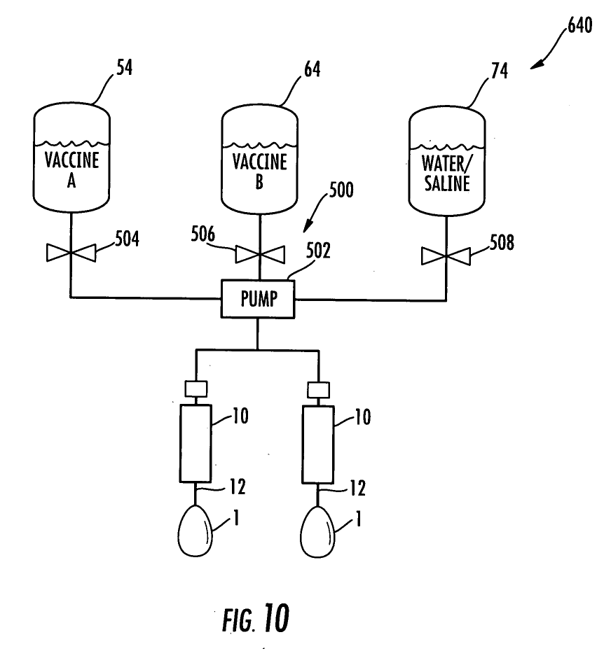

FIG. 9 is a schematic illustration of an in ovo injection apparatus 540 for injecting multiple substances sequentially into multiple eggs in accordance with other embodiments of the present invention. Rather than utilizing a single pump (such as pump 502 in FIG. 8), the illustrated in ovo injection apparatus 540 utilizes delivery devices 10′ with integral pumps. In ovo delivery devices with integral pumps are described in co-owned U.S. Patent Application Publication No. 2007/0044721, entitled In Ovo Injection Delivery Device With Integrated Pump and Injection Needle, which is incorporated herein by reference in its entirety.

Operation of the in ovo injection apparatus 540 is similar to that of the in ovo injection apparatus 440 of FIG. 8. The pump in each delivery device 10′ is in selective fluid communication with a first substance reservoir 54 and a second substance reservoir 64. The pump in each delivery device 10′ can be isolated from the first and second substance reservoirs 54, 64 via valves 504, 506, as described above with respect to FIG. 8.

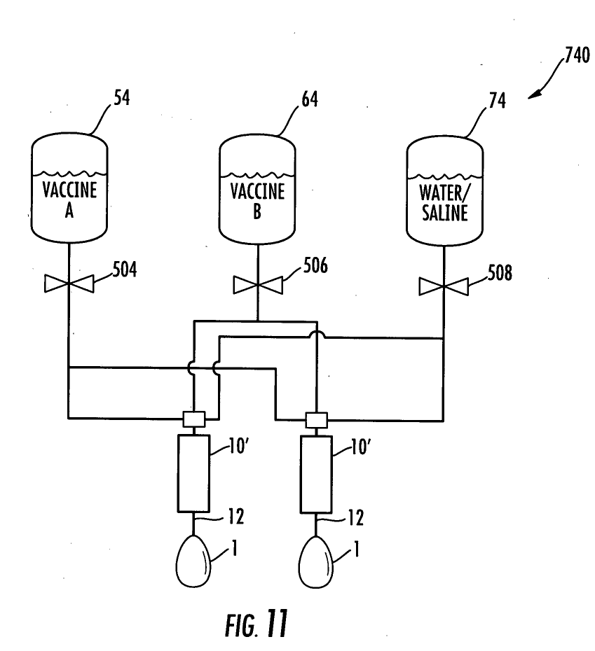

FIG. 10 is a schematic illustration of an in ovo injection apparatus 640 for injecting multiple substances sequentially into multiple eggs in accordance with some embodiments of the present invention. The illustrated apparatus 640 includes a pair of delivery devices 10, each configured to sequentially deliver predetermined dosages of two or more substances into an egg. However, it is understood that an apparatus according to embodiments of the present invention may have any number of delivery devices 10. The illustrated apparatus 640 also includes a substance delivery system 500 that pumps first and second substances sequentially through the needle 12 of each delivery device 10. The substance delivery system includes a pump 502 that is in selective fluid communication with a first substance reservoir 54, a second substance reservoir 64, and an inert substance reservoir 74. The pump 502 can be isolated from the first and second substance reservoirs 54, 64 via valves 504, 506, and from the inert substance reservoir 74 via valve 508, as illustrated. Valves 504, 506, 508 can be any type of valves. Pump 502 can be any type of pump, such as a peristaltic pump, etc.

When pumping the first substance through each delivery device, valve 504 is opened and valves 506 and 508 are closed to isolate the pump 502 from the second substance reservoir and the inert substance reservoir. Similarly, when pumping the second substance through each delivery device, valve 506 is opened and valves 504 and 508 are closed to isolate the pump 502 from the first substance reservoir and the inert substance reservoir 74. Similarly, when pumping the inert substance through each delivery device, valve 508 is opened and valves 504 and 506 are closed to isolate the pump 502 from the first substance reservoir and the second substance reservoir 64. Accordingly, sequential delivery of the first substance, the second substance, and the inert substance can be accomplished with a single pump by controlling the opening and closing of the valves 504, 506, 508, as would be understood by one skilled in the art of the present invention.

Embodiments of the invention illustrated in FIG. 10 may be utilized to sequentially deliver multiple substances to different locations within an egg 1. For example, valves 504, 506, 508 may be initially closed as an injection needle is moved into embryo muscle. Valve 504 is then opened, connecting the first substance reservoir 54 containing vaccine “A” to the pump 502. The pump 502 delivers a predetermined amount of vaccine “A” (e.g., 50 uL, etc.) through the injection needle 12 and into the embryo muscle. The delivery device is moved upwardly (or downwardly) within the egg such that the injection needle is located within the amnion of the egg. Valve 504 is closed and valve 508 is opened, connecting the inert substance reservoir 74 to the pump 502. The pump 502 delivers a predetermined amount of the inert substance (e.g., 50 uL, etc.) through the injection needle 12. Delivery of the inert substance through the injection needle 12 may occur when the needle is still located within the embryo muscle, as the needle is being moved from the muscle to the amnion, or after the needle is located in the amnion, as described above. Valve 508 is closed and valve 506 is opened, connecting the second substance reservoir 64 containing vaccine “B” to the pump 502. The pump 502 delivers a predetermined amount of vaccine “B” (e.g., 50 uL, etc.) through the injection needle 12 and into the embryo amnion. Valve 506 is then closed and the injection needle 12 is withdrawn from the egg 1.

FIG. 11 is a schematic illustration of an in ovo injection apparatus 740 for injecting multiple substances sequentially into multiple eggs in accordance with other embodiments of the present invention. Rather than utilizing a single pump (such as pump 502 in FIG. 10), the illustrated in ovo injection apparatus 740 utilizes delivery devices 10′ with integral pumps, as described above. Operation of the in ovo injection apparatus 740 is similar to that of the in ovo injection apparatus 640 of FIG. 10. The pump in each delivery device 10′ is in selective fluid communication with a first substance reservoir 54, a second substance reservoir 64, and an inert substance reservoir 74. The pump in each delivery device 10′ can be isolated from the first and second substance reservoirs 54, 64 via valves 504, 506, and from the inert substance reservoir 74 via valve 508, as described above with respect to FIG. 10.

Embodiments of the present invention can substantially reduce the time that incompatible in ovo substances are in contact with each other. Moreover, in some embodiments, multiple in ovo substances can be substantially isolated from each other.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of injecting multiple substances in ovo, comprising:
introducing a small opening into the shell of an egg;
extending a delivery device through the opening and into the egg;
pumping first and second substances through the delivery device and into the egg, wherein the first substance is pumped through the delivery device via a first substance delivery system and wherein the second substance is pumped through the delivery device via a second substance delivery system; and
retracting the delivery device from the egg.

2. The method of claim 1, wherein the first and second substances are pumped substantially simultaneously through the delivery device.

3. The method of claim 1, wherein the first and second substances are pumped sequentially through the delivery device.

4. The method of claim 1, wherein the first substance delivery system comprises a first pump in fluid communication with a first substance reservoir, and wherein the second substance delivery system comprises a second pump in fluid communication with a second substance reservoir.

5. The method of claim 1, wherein the opening is introduced by piercing the shell with a punch.

6. The method of claim 1, further comprising flushing the delivery device with a sanitizing solution after pumping the first and second substances into the egg.

7. The method of claim 1, further comprising pumping an inert substance through the delivery device prior to pumping the first and second substances through the delivery device.

8. The method of claim 1, further comprising pumping an inert substance through the delivery device after pumping the first and second substances through the delivery device.

9. The method of claim 3, further comprising pumping an inert substance through the delivery device after the first substance is pumped through the delivery device and before the second substance is pumped through the delivery device.

10. The method of claim 7, wherein pumping the inert substance through the delivery device begins as the delivery device is being extended into the egg.

11. The method of claim 8, wherein pumping the inert substance through the delivery device begins as the delivery device is being retracted from the egg.

12. The method of claim 1, wherein the first and second substances are incompatible.

13. The method of claim 1, wherein one of the first and second substances is an oil-based substance and the other is an aqueous-based substance.

14. A method of injecting multiple substances in ovo, comprising:
introducing a small opening into the shell of an egg;
extending a delivery device through the opening and to a first location within the egg;
pumping a first substance through the delivery device and into the egg at the first location;
pumping an inert substance through the delivery device;
moving the delivery device to a second location within the egg;
pumping a second substance through the delivery device and into the egg at the second location; and
retracting the delivery device from the egg.

15. The method of claim 14, wherein the first substance is pumped through the delivery device via a first substance delivery system, and wherein the second substance is pumped through the delivery device via a second substance delivery system.

16. The method of claim 15, wherein the first substance delivery system comprises a first pump in fluid communication with a first substance reservoir, and wherein the second substance delivery system comprises a second pump in fluid communication with a second substance reservoir.

17. The method of claim 14, wherein the first and second substances are pumped through the delivery device via a pump in selective fluid communication with a first substance reservoir and a second substance reservoir, wherein the pump is isolated from the second substance reservoir when the first substance is pumped through the delivery device, and wherein the pump is isolated from the first substance reservoir when the second substance is pumped through the delivery device.

18. The method of claim 17, wherein the pump is integral with the delivery device.

19. The method of claim 14, wherein the opening is introduced by piercing the shell with a punch.

20. The method of claim 14, further comprising flushing the delivery device with a sanitizing solution after pumping the second substance into the egg.

21. The method of claim 14, further comprising pumping an inert substance through the delivery device prior to pumping the first substance through the delivery device.

22. The method of claim 14, further comprising pumping an inert substance through the delivery device after pumping the second substance through the delivery device.

23. The method of claim 21, wherein pumping the inert solution through the delivery device begins as the delivery device is being extended into the egg.

24. The method of claim 22, wherein pumping the inert solution through the delivery device begins as the delivery device is being retracted from the egg.

25. The method of claim 14, wherein the first and second substances are incompatible.

26. The method of claim 14, wherein one of the first and second substances is an oil-based substance and the other is an aqueous-based substance.

27. The method of claim 14, wherein one of the first and second locations is within an embryo in the egg, and wherein the other of the first and second locations is within amnion in the egg.

28. The method of claim 14, wherein one of the first and second locations is at a depth of about one inch (1″) from the opening, and wherein the other one of the first and second locations is at a depth of about one and one-half inches (1.5″) from the opening.

29. The method of claim 14, wherein the step of pumping the first substance through the delivery device begins prior to the delivery device reaching the first location.

30. The method of claim 14, wherein the step of pumping the second substance through the delivery device begins prior to the delivery device reaching the second location.

31. An in ovo injection apparatus, comprising:
a delivery device configured to contact an egg and deliver predetermined dosages of two substances into the egg;
a first substance delivery system that pumps a first substance through the delivery device; and
a second substance delivery system that pumps a second substance through the delivery device.

32. The apparatus of claim 31, wherein the first and second substance delivery systems pump the respective first and second substances through the delivery device substantially simultaneously.

33. The apparatus of claim 31, wherein the first and second substance delivery systems pump the respective first and second substances through the delivery device sequentially.

34. The apparatus of claim 31, wherein the first substance delivery system comprises a first pump in fluid communication with a first substance reservoir, and wherein the second substance delivery system comprises a second pump in fluid communication with a second substance reservoir.

35. The apparatus of claim 31, wherein the delivery device comprises:
a tubular punch for forming an opening in the shell of an egg; and
an injection needle positioned within the tubular punch for movement therethrough and through an opening in an egg shell formed by the tubular punch for delivery of the first and second substances into an egg.

36. The apparatus of claim 31, further comprising a sanitizing system that flushes the delivery device with a sanitizing solution after pumping the first and second substances into an egg.

37. The apparatus of claim 31, further comprising an inert substance delivery system that pumps an inert solution through the delivery device.

38. The apparatus of claim 37, wherein the inert substance delivery system comprises a pump in fluid communication with an inert substance reservoir.

39. The apparatus of claim 37, wherein the inert substance delivery system is configured to pump an inert solution through the delivery device before the first and second substances are pumped through the delivery device.

40. The apparatus of claim 37, wherein the inert substance delivery system is configured to pump an inert solution through the delivery device after the first and second substances are pumped through the delivery device.

41. The apparatus of claim 37, wherein the inert substance delivery system is configured to pump an inert solution through the delivery device after the first substance is pumped through the delivery device and before the second substance is pumped through the delivery device.

42. The apparatus of claim 31, wherein the first and second substances are incompatible.

43. The apparatus of claim 31, wherein one of the first and second substances is an oil-based substance and the other is an aqueous-based substance.

44. An in ovo injection apparatus, comprising:
a delivery device configured to contact an egg and deliver a predetermined dosage of a first substance at a first location within the egg and a predetermined dosage of a second substance at a second location within the egg;
a first substance delivery system that pumps a first substance through the delivery device; and
a second substance delivery system that pumps a second substance through the delivery device.

45. The apparatus of claim 44, wherein one of the first and second locations is within an embryo in the egg, and wherein the other of the first and second locations is within amnion in the egg.

46. The apparatus of claim 44, wherein one of the first and second locations is at a depth of about one inch (1″) from the opening, and wherein the other one of the first and second locations is at a depth of about one and one-half inches (1.5″) from the opening.

47. The apparatus of claim 44, wherein the first substance delivery system comprises a first pump in fluid communication with a first substance reservoir, and wherein the second substance delivery system comprises a second pump in fluid communication with a second substance reservoir.

48. The apparatus of claim 44, wherein the delivery device comprises:
a tubular punch for forming an opening in the shell of an egg; and
an injection needle positioned within the tubular punch for movement therethrough and through an opening in an egg shell formed by the tubular punch for delivery of the first and second substances into an egg.

49. The apparatus of claim 44, further comprising a sanitizing system that flushes the delivery device with a sanitizing solution after pumping the first and second substances into an egg.

50. The apparatus of claim 44, further comprising an inert substance delivery system that pumps an inert solution through the delivery device.

51. The apparatus of claim 50, wherein the inert substance delivery system comprises a pump in fluid communication with an inert substance reservoir.

52. The apparatus of claim 50, wherein the inert substance delivery system is configured to pump an inert solution through the delivery device before the first and second substances are pumped through the delivery device.

53. The apparatus of claim 50, wherein the inert substance delivery system is configured to pump an inert solution through the delivery device after the first and second substances are pumped through the delivery device.

54. The apparatus of claim 50, wherein the inert substance delivery system is configured to pump an inert solution through the delivery device after the first substance is pumped through the delivery device and before the second substance is pumped through the delivery device.

55. An in ovo injection apparatus, comprising:
an egg carrier that holds a plurality of eggs and provides external access to the eggs;
a plurality of delivery devices positioned above the carrier, wherein each delivery device is configured to contact a respective egg in the carrier and deliver predetermined dosages of two substances into the egg;
a first substance delivery system that pumps a first substance through each delivery device; and
a second substance delivery system that pumps a second substance through each delivery device.

56. The apparatus of claim 55, wherein the first and second substance delivery systems pump the respective first and second substances through each delivery device substantially simultaneously.

57. The apparatus of claim 55, wherein the first and second substance delivery systems pump the respective first and second substances through each delivery device sequentially.

58. The apparatus of claim 55, wherein the first substance delivery system comprises a first set of pumps in fluid communication with a first substance reservoir and a second set of pumps in fluid communication with a second substance reservoir, wherein a respective one of the pumps in the first set pumps the first substance to a respective one of the delivery devices, and wherein a respective one of the pumps in the second set pumps the second substance to a respective one of the delivery devices.

59. The apparatus of claim 55, wherein each delivery device comprises:
a tubular punch for forming an opening in the shell of an egg; and
an injection needle positioned within the tubular punch for movement therethrough and through an opening in an egg shell formed by the tubular punch for delivery of the first and second substances into an egg.

60. The apparatus of claim 55, further comprising a sanitizing system that flushes each delivery device with a sanitizing solution after pumping the first and second substances into an egg.

61. The apparatus of claim 55, further comprising an inert substance delivery system that pumps an inert solution through each delivery device.

62. The apparatus of claim 61, wherein the inert substance delivery system comprises a set of pumps in fluid communication with an inert substance reservoir, wherein a respective one of the pumps in the set pumps the inert substance to a respective one of the delivery devices.

63. The apparatus of claim 61, wherein the inert substance delivery system is configured to pump an inert solution through each delivery device before the first and second substances are pumped through the delivery device.

64. The apparatus of claim 61, wherein the inert substance delivery system is configured to pump an inert solution through each delivery device after the first and second substances are pumped through the delivery device.

65. The apparatus of claim 61, wherein the inert substance delivery system is configured to pump an inert solution through each delivery device after the first substance is pumped through the delivery device and before the second substance is pumped through the delivery device.

66. A method of injecting multiple substances in ovo, comprising:
introducing a small opening into the shell of an egg;
extending a delivery device through the opening and into the egg;
sequentially pumping first and second substances through the delivery device and into the egg via a pump in selective fluid communication with a first substance reservoir and a second substance reservoir, wherein the pump is isolated from the second substance reservoir when the first substance is pumped through the delivery device and wherein the pump is isolated from the first substance reservoir when the second substance is pumped through the delivery device; and
retracting the delivery device from the egg.

67. The method of claim 66, further comprising flushing the delivery device with a sanitizing solution after pumping the first and second substances into the egg.

68. The method of claim 66, further comprising pumping an inert substance through the delivery device prior to pumping the first and second substances through the delivery device.

69. The method of claim 66, further comprising pumping an inert substance through the delivery device after pumping the first and second substances through the delivery device.

70. The method of claim 66, further comprising pumping an inert substance through the delivery device after the first substance is pumped through the delivery device and before the second substance is pumped through the delivery device.

71. The method of claim 68, wherein pumping the inert substance through the delivery device begins as the delivery device is being extended into the egg.

72. The method of claim 69, wherein pumping the inert substance through the delivery device begins as the delivery device is being retracted from the egg.

73. The method of claim 66, wherein the first and second substances are incompatible.

74. The method of claim 66, wherein one of the first and second substances is an oil-based substance and the other is an aqueous-based substance.

75. The method of claim 66, wherein the pump is integral with the delivery device.

76. An in ovo injection apparatus, comprising:
a delivery device configured to contact an egg and deliver predetermined dosages of two substances into the egg; and
a substance delivery system that pumps first and second substances sequentially through the delivery device, comprising a pump in selective fluid communication with a first substance reservoir and a second substance reservoir, wherein the pump is isolated from the second substance reservoir when the first substance is pumped through the delivery device, and wherein the pump is isolated from the first substance reservoir when the second substance is pumped through the delivery device.

77. The apparatus of claim 76, wherein the delivery device comprises:
a tubular punch for forming an opening in the shell of an egg; and
an injection needle positioned within the tubular punch for movement therethrough and through an opening in an egg shell formed by the tubular punch for delivery of the first and second substances into an egg.

78. The apparatus of claim 76, further comprising a sanitizing system that flushes the delivery device with a sanitizing solution after pumping the first and second substances into an egg.

79. The apparatus of claim 76, wherein the substance delivery system is in selective fluid communication with an inert substance reservoir and is configured to pump an inert substance from the inert substance reservoir through the delivery device.

80. The apparatus of claim 76, wherein the first and second substances are incompatible.

81. The apparatus of claim 76, wherein one of the first and second substances is an oil-based substance and the other is an aqueous-based substance.

82. The apparatus of claim 76, wherein the pump is integral with the delivery device.

83. An in ovo injection apparatus, comprising:
an egg carrier that holds a plurality of eggs and provides external access to the eggs;
a plurality of delivery devices positioned above the carrier, wherein each delivery device is configured to contact a respective egg in the carrier and deliver predetermined dosages of two substances into the egg; and
a substance delivery system that pumps first and second substances sequentially through the delivery devices, wherein the substance delivery system comprises a pump in selective fluid communication with a first substance reservoir and a second substance reservoir, wherein the pump is isolated from the second substance reservoir when the first substance is pumped through the delivery devices, and wherein the pump is isolated from the first substance reservoir when the second substance is pumped through the delivery devices.

84. The apparatus of claim 83, wherein each delivery device comprises:
a tubular punch for forming an opening in the shell of an egg; and
an injection needle positioned within the tubular punch for movement therethrough and through an opening in an egg shell formed by the tubular punch for delivery of the first and second substances into an egg.

85. The apparatus of claim 83, further comprising a sanitizing system that flushes each delivery device with a sanitizing solution after pumping the first and second substances into an egg.

86. The apparatus of claim 83, wherein the substance delivery system is in selective fluid communication with an inert substance reservoir and is configured to pump an inert substance from the inert substance reservoir through each delivery device.

87. The apparatus of claim 83, wherein the first and second substances are incompatible.

88. The apparatus of claim 87, wherein one of the first and second substances is an oil-based substance and the other is an aqueous-based substance.

89. An in ovo injection apparatus, comprising:
an egg carrier that holds a plurality of eggs and provides external access to the eggs;
a plurality of delivery devices positioned above the carrier, wherein each delivery device is configured to contact a respective egg in the carrier and deliver predetermined dosages of two substances into the egg via a pump integral with the delivery device; and
wherein each delivery device pump is in selective fluid communication with a first substance reservoir and a second substance reservoir, wherein each delivery device pump is isolated from the second substance reservoir when the first substance is pumped therethrough, and wherein each delivery device pump is isolated from the first substance reservoir when the second substance is pumped therethrough.

90. The apparatus of claim 89, further comprising a sanitizing system that flushes the delivery device with a sanitizing solution after pumping the first and second substances into an egg.

91. The apparatus of claim 89, wherein each delivery device pump is in selective fluid communication with an inert substance reservoir and is configured to pump an inert substance from the inert substance reservoir through the delivery device.
